(19) United States
(12) Patent Application Publication
(10) Pub. No.: US 2025/0301033 A1
(43) Pub. Date: Sep. 25, 2025

(54) BIT-RATE SELECTION APPARATUS, BIT-RATE SELECTION METHOD AND PROGRAM

(71) Applicant: NIPPON TELEGRAPH AND TELEPHONE CORPORATION, Tokyo (JP)

(72) Inventors: Masahiro YOKOTA, Tokyo (JP); Taichi KAWANO, Tokyo (JP); Kazuhisa YAMAGISHI, Tokyo (JP)

(21) Appl. No.: 18/860,843

(22) PCT Filed: May 2, 2023
(86) PCT No.: PCT/JP2023/017171

§ 371 Date: Oct. 28, 2024

(30) Foreign Application Priority Data
May 11, 2022 (WO) PCT/JP2022/019985

(51) Int. Cl. H04L 65/80; H04L 65/403; H04N 19/115; H04N 19/164; H04N 19/184

(52) U.S. Cl. CPC H04L 65/80; H04L 65/403; H04N 19/115; H04N 19/164; H04N 19/184

(57) ABSTRACT

A bit rate selection device includes a memory, and a processor that: selects bit rates of videos for each of combinations of a plurality of first terminals and a plurality of second terminals from a plurality of levels of values such that a sum of the bit rates of the videos for each of the combinations is minimized under a constraint that each of the second terminals receives the videos transmitted from each of the first terminals via a distribution device in online real-time communication and a quality of experience of each of the videos for a user of each of the second terminals is equal to or higher than a threshold value; and transmits, to each of the first terminals, an instruction for instructing each of the first terminals to perform encoding at one or more bit rates selected for each of the combinations related to the first terminals.

### TECHNICAL FIELD

The present invention relates to a bit rate selection device, a bit rate selection method, and a program.

### BACKGROUND ART

In recent years, as telework has been promoted, the use of online real-time communication services such as web meetings has increased. As a technique for realizing such a service, there is a technique such as WebRTC. WebRTC is a technique that is standardized by the World Wide Web Consortium and the Internet Engineering Task Force.

By using such a technique, online real-time communication services can be realized. However, in order to continuously provide such a service to end users, it is necessary to increase a quality of experience (QoE) of a user when the user uses the service and to reduce an operation cost (a network facility cost or the like) required for service provision.

In WebRTC, three architectures are proposed to realize a multi-party meeting. (1) P2P in which participating terminals are connected in a full mesh, (2) multi-point control unit in which each of clients transmits video data to a server and the server performs transcoding of the video data and distributes the video data to the participating clients, and (3) selective forwarding unit (SFU) in which each of clients transmits video data to a server and the server distributes the video as it is to the participating clients.

In the SFU scheme, since video having the same quality is distributed to all the participating clients, the scheme has a problem that, in a case where a participant with a poor network status is present, the overall quality is degraded due to the participant.

In order to cope with this problem, a Simulcast scheme has been proposed. In the Simulcast, transmission source clients transmit videos having a plurality of levels of qualities (a bit rate, resolution, a frame rate) to a server. The server selects a quality according to a network status of each client, and performs distribution with the selected quality. For example, the transmission source clients perform encoding of videos having a high quality (1 Mbps/720 p/30 fps), a medium quality (480 kbps/480 p/30 fps), and a low quality (128 kbps/180 p/15 fps), and transmit the encoded videos to the distribution server. The distribution server distributes video having a high quality to a transmission destination client having a sufficiently wide download band, and distributes video having a low quality to a transmission destination client having a narrow download band.

It is considered to manually set a quality level in a Simulcast. In addition, it is considered to change a quality (a bit rate, resolution, a frame rate) that can be appropriately selected according to a network state of a reception-side client (Non Patent Literature 1).

On the other hand, in WebRTC, control in consideration of not only quality improvement but also cost has been proposed. In this control, a video bit rate of each terminal is controlled such that the quality reaches a target QoE which is set by a service provider. Thereby, the QoE is maintained, and the data transmission amount is reduced. Therefore, an operation cost of the service provider is reduced (Non Patent Literature 2).

### CITATION LIST

### Non Patent Literature

Non Patent Literature 1: S. Petrangeli, “Dynamic video bitrate adaptation for WebRTC-based remote teaching applications”, IEEE, 2018
Non Patent Literature 2: T. Kimura, T. Kimura, A. Matsumoto and J. Okamoto, “BANQUET: Balancing Quality of Experience and Traffic Volume in Adaptive Video Streaming”, IEEE CNSM 2019 Feb. 2020
Non Patent Literature 3: Parametric bitstream-based quality assessment of progressive download and adaptive audiovisual streaming services over reliable transport, Recommendation ITU-T P.1203, 2017, [online], Internet <URL: https://www.itu.int/rec/T-REC-P.1203>

### SUMMARY OF INVENTION

### Technical Problem

In the existing Simulcast, a level of a quality (a video bit rate, resolution, a frame rate) is set according to knowledge of an operator or a network situation. For this reason, there is a likelihood that encoding is set to be performed at an excessively high bit rate. At that time, in a case where the network situation is very good, an excessive bit rate may be selected, and a high bit rate may be selected even though the QoE is not improved much. As a result, there is a risk of an increase in the operation cost for a network facility and a server facility required by the service provider.

A video bit rate control technique (Non Patent Literature 2) for reducing a transmission data amount has been proposed in order to cope with the problem of an increase in the data amount as described above. However, this technique is aimed at a video distribution service, and is not a technique considering the Simulcast of a web meeting service. From these situations, in order to suppress an excessive quality in the Simulcast scheme, a method for appropriately controlling a plurality of patterns of bit rates for upload by each terminal is required.

The present invention has been made in view of the above points, and an object of the present invention is to reduce a likelihood that an excessive bit rate is selected when encoding a video.

### Solution to Problem

Therefore, in order to solve the above problem, there is provided a bit rate selection device including: a selection unit that selects bit rates of videos for each of combinations of a plurality of first terminals and a plurality of second terminals from a plurality of levels of values such that a sum of the bit rates of the videos for each of the combinations is minimized under a constraint that each of the plurality of second terminals receives the videos transmitted from each of the plurality of first terminals via a distribution device in online real-time communication and a quality of experience of each of the videos for a user of each of the plurality of second terminals is equal to or higher than a threshold value; and an instruction unit that transmits, to each of the plurality of first terminals, an instruction for instructing each of the plurality of first terminals to perform encoding at one or more bit rates selected by the selection unit for each of the combinations related to the first terminals.

### Advantageous Effects of Invention

It is possible to reduce a likelihood that an excessive bit rate is selected when encoding a video.

### BRIEF DESCRIPTION OF DRAWINGS

FIG. 1 is a diagram illustrating a configuration example of an online real-time communication system according to a first embodiment.

FIG. 2 is a diagram illustrating a hardware configuration example of a control server 10 according to the first embodiment.

FIG. 3 is a diagram illustrating functional configuration examples of a client terminal 20 and a control server 10 according to the first embodiment.

### DESCRIPTION OF EMBODIMENTS

In the present embodiment, upload bit rates are controlled for each of sets of transmission sources x transmission destinations such that a quality of experience (QoE) estimated from T1 seconds before the current timing to T2 seconds after the current timing approaches a target QoE based on information related to a quality that is collected from a client, information related to the client, information related to an available upload band, and information related to an available download band. Thereby, it is possible to suppress a data communication amount while maintaining a required QoE.

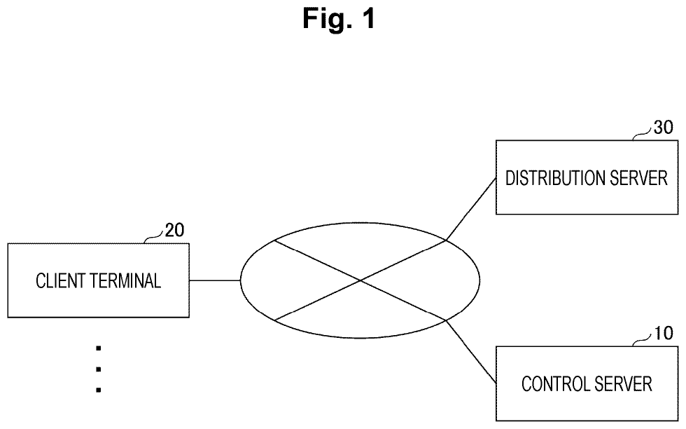

Hereinafter, an embodiment of the present invention will be described with reference to the drawings. FIG. 1 is a diagram illustrating a configuration example of an online real-time communication system according to a first embodiment. In FIG. 1, a plurality of client terminals 20 are connected to a distribution server 30 and a control server 10 via a network such as the Internet.

Each of the plurality of client terminals 20 is a communication terminal such as a personal computer (PC), a smartphone, or a tablet terminal used by a user participating in online real-time communication such as a web meeting. The client terminal 20 transmits various logs to the control server 10, encodes and transmits data (hereinafter, referred to as “media data”) related to media (video, audio, and the like) according to an instruction of the control server 10, and receives and reproduces media data of other participants. Each client terminal 20 transmits, for example, media data of the user of the own client terminal. Each client terminal 20 also receives media data from another terminal, and displays a screen including each of pieces of media data.

The control server 10 is one or more computers that instruct an upload bit rate for each client terminal 20.

The distribution server 30 is one or more computers that distribute media data transmitted (uploaded) from each client terminal 20 to other client terminals 20. Regarding the distribution to the other client terminals 20, the distribution server 30 performs distribution at an optimum bit rate according to the download bands of the other client terminals 20. That is, the distribution server 30 distributes the media data at a bit rate according to the download band of each client terminal 20 by the Simulcast scheme of WebRTC.

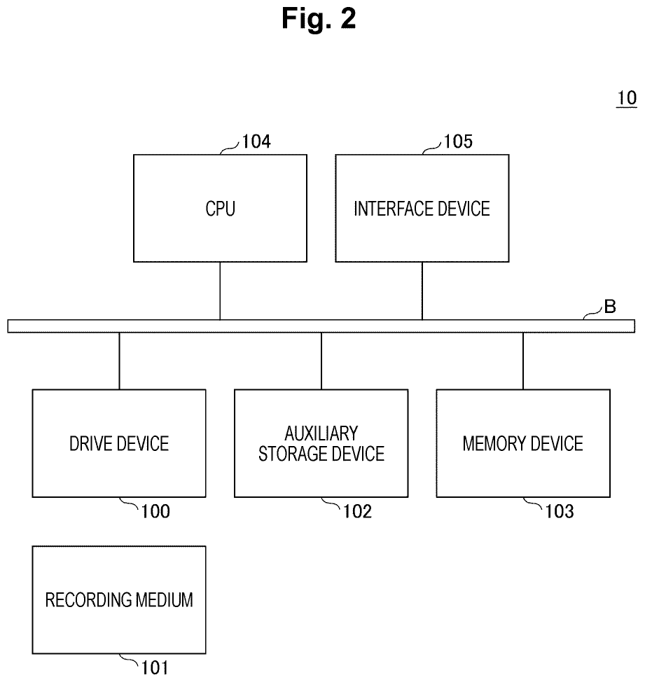

FIG. 2 is a diagram illustrating a hardware configuration example of the control server 10 according to the first embodiment. The control server 10 in FIG. 2 includes a drive device 100, an auxiliary storage device 102, a memory device 103, a CPU 104, an interface device 105, and the like which are connected to each other by a bus B.

A program for implementing processing in the control server 10 is provided by a recording medium 101 such as a CD-ROM. When the recording medium 101 storing the program is set in the drive device 100, the program is installed from the recording medium 101 to the auxiliary storage device 102 via the drive device 100. Here, the program is not necessarily installed from the recording medium 101 and may be downloaded from another computer via a network. The auxiliary storage device 102 stores the installed program and also stores files, data, and the like which are required.

In a case where an instruction to start the program is received, the memory device 103 reads the program from the auxiliary storage device 102 and stores the program. The CPU 104 executes a function of the control server 10 according to the program stored in the memory device 103. The interface device 105 is used as an interface for connection to a network.

Note that the client terminal 20 and the distribution server 30 may also have a hardware configuration similar to the configuration in FIG. 2. Here, the client terminal 20 includes a display device and a speaker for outputting media data, a camera and a microphone for inputting media data, and the like.

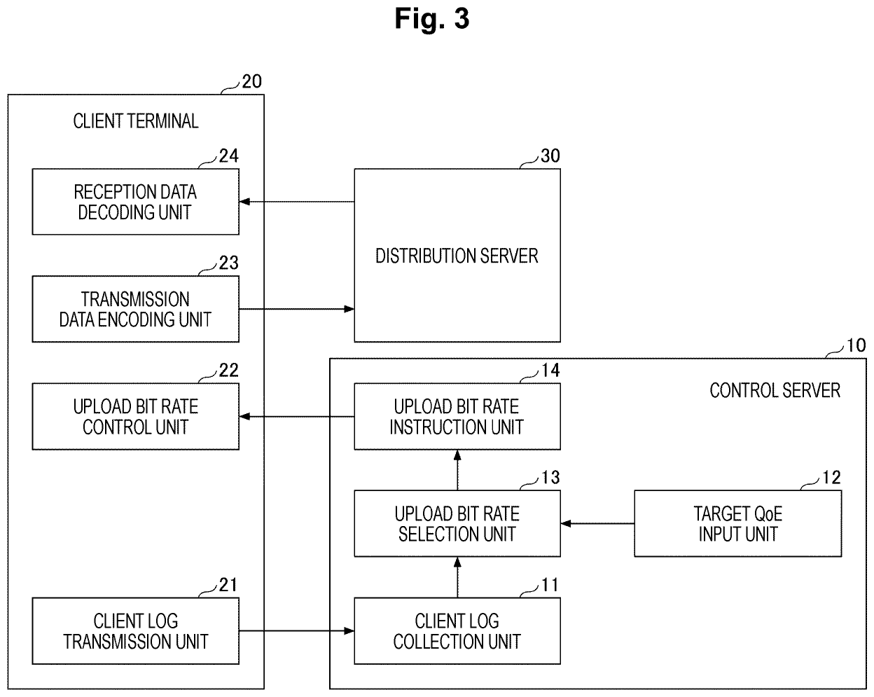

FIG. 3 is a diagram illustrating functional configuration examples of the client terminal 20 and the control server 10 according to the first embodiment.

In FIG. 3, the client terminal 20 includes a client log transmission unit 21, an upload bit rate control unit 22, a transmission data encoding unit 23, and a reception data decoding unit 24. Each of these units is implemented by processing that one or more programs installed in the client terminal 20 cause the CPU of the client terminal 20 to execute.

The control server 10 includes a client log collection unit 11, a target QoE input unit 12, an upload bit rate selection unit 13, and an upload bit rate instruction unit 14. Each of these units is implemented by processing that one or more programs installed in the control server 10 cause the CPU 104 to execute.

A processing procedure executed according to the present embodiment will be described with reference to FIG. 3. Note that the following processing is executed during an execution of online real-time communication (hereinafter, simply referred to as a “web meeting”) such as a web meeting unless otherwise specified. In addition, the following processing is executed for each of the plurality of client terminals 20 participating in the web meeting.

The client log transmission unit 21 of each client terminal 20 periodically (for example, in a cycle of 1 second) collects a log (hereinafter, referred to as a “client log”) including information required for estimation of a quality (information in the cycle) and information required for estimation of an upload bit rate (information in the cycle) from the client terminal 20 after the start of the web meeting, and transmits the collected client log to the control server 10.

The information required for estimation of a quality includes, for example, information related to a quality of each received video (a bit rate, reproduction stop information (a reproduction stop time, the number of times of reproduction stops, an interval of reproduction stops, and the like), a frame rate, a resolution) and information related to the client terminal 20 (information for identifying a type of a used terminal (own terminal), and a display size (a display area)). Each received video has the same meaning as for each of the other client terminals 20 (for each of videos from the other client terminals). For example, in a case where A, B, and C are holding a meeting, each received video in the client terminal 20 of A refers to each of videos of B and C. The reason why the display size is collected for each received video is that it is assumed that the display size (that is, a size on a screen on which the other participants are displayed) may be different for each received video. For example, in a case where A, B, and C are holding a meeting, in the present embodiment, a situation where the display size of B and the display size of C are different in the client terminal 20 of A is also considered.

The information required for estimation of an upload bit rate includes, for example, an available upload band and an available download band of each user (each client terminal 20).

The client log collection unit 11 of the control server 10 receives the client log transmitted from the client log transmission unit 21. Note that the information included in the client log may be collected on the control server 10 side as long as the information can be collected on the control server 10 side.

The control server 10 basically executes the following processing in response to reception of the client log. Here, the following processing may not be executed every time the client log is received.

The upload bit rate selection unit 13 of the control server 10 calculates upload bit rates for each of sets of transmission sources x transmission destinations such that an amount of transmission data (a sum of the bit rates for each of sets of transmission sources x transmission destinations) is minimized based on Expression (1).

$$\begin{matrix}[ Math . 1 ] & \\ min {\sum }_{u ∈ U} {\sum }_{i ∈ U , i \neq u} B {R}_{i , u} ( T ) & ( 1 )\end{matrix}$$

$$B {R}_{i , u} ( r ) ∈ L$$

Here, meaning of each symbol is as follows.
U: a participant user group
BR_{i,u}(t): a bit rate of a video of a user i that is received by a user u at a timing t (an upload bit rate for i (a transmission source) and a reception bit rate for u (a transmission destination))
L: a plurality of levels of selectable bit rate groups

Note that the upload bit rates for each of sets of transmission sources x transmission destinations refer to, for example, 5×4=20 bit rates in a case where there are 5 participants. Note that, among the upload bit rates for each of sets of transmission sources x transmission destinations, an upload bit rate for a set of a certain transmission source and a certain transmission destination is a bit rate in a case where the transmission source uploads data to the distribution server 30, and is a bit rate (a reception bit rate) of a received video that is distributed from the distribution server 30 to the transmission destination.

Further, the timing t is a preset timing to change the upload bit rate, and an interval between the timings to change the upload bit rate is, for example, the same as a collection cycle of the client log.

Here, in order to achieve the target QoE, the upload bit rate selection unit 13 calculates Expression (1) so as to satisfy the following three constraints 1 to 3.

### (Constraint 1)

The constraint 1 is expressed by the following Expression (2).

$$\begin{matrix}[ Math . 2 ] & \\ {QoE}_{u} \geq TargetQoE & ( 2 )\end{matrix}$$

$$u ∈ U$$

Here, meaning of each symbol is as follows.
U: a participant user group
TargetQoE: a target QoE that is set as a threshold value

That is, the constraint 1 is that the estimated QoE of each user needs to be equal to or higher than the target QoE (TargetQoE).

### (Constraint 2)

The constraint 2 is expressed by the following Expression (3).

$$\begin{matrix}[ Math . 3 ] & \\ {\sum }_{u ∈ U , u \neq i} B {R}_{i , u} ( t ) \leq α \cdot {ULBW}_{i} ( t ) & ( 3 )\end{matrix}$$

Here, meaning of each symbol is as follows.
BR_{i,u}(t): a bit rate of a video of a user i that is received by a user u at a timing t
ULBWᵢ(t): an estimated available upload band for a user i at a timing t
α: a safety factor to which an estimation error is added (takes a value of 0 to 1)

That is, the constraint 2 is that a sum of the upload bit rates of each user needs to be within the available upload band. Here, it is not necessary to redundantly sum the same upload bit rate from the same transmission source (that is, the upload bit rates are summed while excluding redundancy of the same upload bit rate from the same transmission source).

### (Constraint 3)

The constraint 3 is expressed by the following Expression (4).

$$\begin{matrix}[ Math . 4 ] & \\ {\sum }_{i ∈ U , i \neq u} B {R}_{i , u} ( t ) \leq α \cdot {DLBW}_{u} ( t ) & ( 4 )\end{matrix}$$

Here, meaning of each symbol is as follows.
BR_{i,u}(t): a bit rate of a video of a user i that is received by a user u at a timing t
DLBWᵤ(t): an estimated available download band for a user u at a timing t
α: a safety factor to which an estimation error is added (takes a value of 0 to 1)

That is, the constraint 3 is that a sum of the download bit rates (=reception bit rates) of each user needs to be a value within the available download band. Note that Expression (2) to Expression (4) represent constraints on an optimization problem represented by Expression (1).

In the calculation of Expression (1), the upload bit rate selection unit 13 selects upload bit rates from the plurality of levels of bit rate groups (L). The bit rate group (L) is given in advance. The bit rate group (L) is set such that QoE is distributed according to the number (N) of selectable bit rates between QoE (hereinafter, referred to as “QoE_{lower}”) to be guaranteed at minimum by a service provider and a maximum QoE (hereinafter, referred to as “QoEᵤₚₚₑᵣ”) to be achieved by a service provider. Expression (5) represents a calculation expression of the bit rate in a case where the QoE is set at constant intervals using a QoE estimation model.

$$\begin{matrix}[ Math . 5 ] & \\ B {R}_{n} = {f}_{Q o E}^{- 1} ( \frac{( Q o {E}_{u pper} - Q o {E}_{l o w e r} )}{( N - 1 )} \cdot n + {QoE}_{l o w e r} ) & ( 5 )\end{matrix}$$

Here, meaning of each symbol is as follows.
BRₙ: an estimated n-th bit rate
n: an integer between 0 and N−1
N: the number of selectable bit rates
QoEᵤₚₚₑᵣ: a maximum QoE to be achieved (e. g., 5)
QoE_{lower}: a QoE to be guaranteed at minimum (e. g., 3)

The QoEs at constant intervals in a case where QoE_{lower}=3, QoEᵤₚₚₑᵣ=5, and N=9 are [3, 3.25, 3.5, 3.75, 4, 4.25, 4.5, 4.75, 5], and BRₙ is calculated for each of these QoEs. Although it is possible to perform flexible control by increasing a value of N, there is a risk that the number of types of upload bit rates increases and a load on the client terminal 20 increases.

QoEᵤ of each user in Expression (2) is calculated from a video transmitted from another user. Specifically, QoEᵤ is a QoE value estimated for a section from T1 seconds before the current timing to T2 seconds after the current timing by using the following Expression (6).

$$\begin{matrix}[ Math . 6 ] & \\ Q o {E}_{u} = f ( {\sum }_{i ∈ U , i \neq u} \frac{D {S}_{i , u} ( t )}{{\sum }_{s ∈ U , s \neq u} D {S}_{s , u} ( t )} * {f}_{Q o E} ( {BR}_{i , u} ( t ) , F {R}_{i , u} ( t ) , RE {S}_{i , u} ( t ) , {STOP}_{i , u} ( t ) ) ) & ( 6 )\end{matrix}$$

Here, meaning of each symbol is as follows.
DS_{i, u}(t): a display size of a user i that is displayed on a screen of a user u at a timing t
BR_{i, u}(t): a bit rate of a video of a user i that is received by a user u at a timing t
FR_{i, u}(t): a frame rate of a video of a user i that is received by a user u at a timing t
RES_{i, u}(t): resolution of a video of a user i that is received by a user u at a timing t
STOP_{i, u}(t): reproduction stop information of a video of a user i that is received by a user u at a timing t

Further, f_{QoE} is a QoE estimation model for estimating QoE from the bit rate, the resolution, the frame rate, and the reproduction stop information. For example, a QoE estimation model disclosed in Non Patent Literature 3 is used.

In addition, f( ) as the outermost term on a right side of Expression (6) represents a formula for estimating long-time QoE. In the present embodiment, it is assumed that control is performed such that a QoE value for a certain period (for example, in a case where T1=30 seconds and T2=30 seconds, a period of 1 minute) approaches the target QoE. At this time, as in Non Patent Literature 3, a QoE value is calculated every t (for example, for 1 second) within the period, and these QoE values are integrated. Thereby, the QoE value for the certain period is estimated. The QoE value for each t (for example, for 1 second) is calculated in f( ) of Expression (6). At this time, since videos of a plurality of other participants are displayed on each client terminal 20, a weighted average by the display size (=DS in Expression (6)) is calculated for an estimated value by f_{QoE}. The results are integrated in f( ).

Specifically, the calculation of Expression (6) is performed as follows.

(Step 1) The upload bit rate selection unit 13 calculates a QoE value of each u for each t from the client log at each t in a section from T1 seconds to the current timing, by using the content of f( ) in Expression (6).

(Step 2) The upload bit rate selection unit 13 calculates a QoE value of each u for each t in a section from the current timing to T2 seconds after the current timing, by using the content of f( ) in Expression (6). At this time, the bit rate (BR_{i, u}(t)) is selected from L. For example, a value of BR_{i, u}(t) may be selected to decrease the bit rate from a relatively high bit rate to a low bit rate as t increases, or a value of BR_{i, u}(t) may be selected to increase the bit rate from a relatively low bit rate to a high bit rate. The bit rate may be selected from L based on other rules. In addition, it is considered that the frame rate, the resolution, and the display size (FR_{i, u}(t), RES_{i, u}(t), DS_{i,u}(t)) are set using a latest value of the client log and the reproduction stop information (STOP_{i, u}(t)) is set to 0. Further, depending on a client application, the frame rate and the resolution may be determined according to the selected bit rate. In such a case, the resolution and the frame rate may be calculated according to a correspondence formula of the bit rate, the frame rate, and the resolution used in the client application.

(Step 3) The upload bit rate selection unit 13 calculates (estimates) QoE, that is a QoE value for a certain period (T1 to T2) for each u, by integrating, for each u in f( ) of Expression (6), the QoE value for each t that is calculated in step 1 and the QoE value for each t that is calculated in step 2.

Note that the upload bit rate selection unit 13 selects BR_{i, u}(t) from L by calculating Expression (1) within a range in which the constraint that QoEᵤ calculated in step 3 exceeds the target QoE is satisfied (Expression (2)) and the constraints of Expression (3) and Expression (4) are also satisfied.

At this time, it is assumed that the available upload band included in the client log from the client log transmission unit 21 is used for T2 seconds as ULBWᵢ(t) and DLBWᵤ(t) in Expression (3) and Expression (4). That is, values of the latest client log may be substituted into ULBWᵢ(t) and DLBWᵤ(t). Note that ULBWᵢ(t) and DLBWᵤ(t) may be estimated using an existing band estimation technique.

The upload bit rate instruction unit 14 instructs each client terminal 20 to perform encoding at the upload bit rate by transmitting the upload bit rate (BR_{i, u}(t)) for each of sets of transmission sources (i) x transmission destinations (u) that is received from the upload bit rate selection unit 13 to the client terminal 20 related to each i. At this time, among the upload bit rates for each of sets of transmission sources (i) x transmission destinations (u), values of all (that is, one or more) upload bit rates related to i are transmitted to a certain transmission source terminal i.

The upload bit rate control unit 22 of the client of the client terminal 20 sets all the upload bit rates received from the upload bit rate instruction unit 14 of the control server 10 to the transmission data encoding unit 23.

The transmission data encoding unit 23 performs encoding of the media data based on the set upload bit rate, and transmits (uploads) the encoded media data to the distribution server 30.

The distribution server 30 distributes the media data uploaded from each client terminal 20 with one or more levels of upload bit rates to the client terminals 20 other than the corresponding client terminal 20. At this time, the distribution server 30 may not necessarily recognize the calculation result (selection result) of BR_{i, u}(t) according to Expression (1). Basically, in the Simulcast, the distribution server 30 determines an appropriate bit rate according to the download band of the client terminal 20 and distributes data. On the other hand, in the present embodiment, the information on the download band is used when BR_{i, u}(t) is calculated, and thus, it is considered that the bit rate selected by the distribution server 30 naturally matches with the calculation result of BR_{i, u}(t).

Alternatively, the calculation result (selection result) of BR_{i, u}(t) may be transmitted from the control server 10 or the client terminal 20 to the distribution server 30.

As described above, according to the first embodiment, the bit rate of the video for each of combinations of the transmission sources and the transmission destinations is selected within a range of achieving the target QoE such that the data transmission amount is minimized. Therefore, it is possible to reduce a likelihood that an excessive bit rate is selected when encoding a video. As a result, it is possible to reduce a cost required for facilities of the service provider.

Next, a second embodiment will be described. In the second embodiment, differences from the first embodiment will be described. Points that are not specifically described in the second embodiment may be similar to those in the first embodiment.

In the second embodiment, a situation is assumed where the number of the upload bit rates is limited to a predetermined number R due to the network of the transmission source terminal and the client load. In this case, it is necessary to determine the limited number (R) of the bit rates for each transmission source terminal.

In the second embodiment, a constraint that the number n(BRᵢ(t)) of the upload bit rates BRᵢ(t) of each transmission source i in Expression (1) is equal to or smaller than R is given. Here, BRᵢ(t) means types (lists) of the upload bit rates from a user i of a certain transmission source to all transmission destinations. In addition, a notation n(X) means the number of X. Due to the constraint, the number of the upload bit rates is limited to R for each transmission source i, and each transmission destination user u is caused to select one bit rate from among R bit rates for a video from each transmission source i. For example, in a case where the number of selectable bit rates that are set in advance is N, the upload bit rate selection unit 13 calculates the upload bit rates for each of sets of transmission sources x transmission destinations such that the transmission data amount (the sum of the bit rates for each of sets of transmission sources x transmission destinations) is minimized based on the following Expression (7-1) instead of Expression (1). At this time, the constraints of Expression (2) to Expression (6) are also effective.

$$\begin{matrix}[ Math . 7 ] & \\ min {\sum }_{u ∈ U} {\sum }_{i ∈ U , i \neq u} {\sum }_{n = 0}^{N - 1} {α}_{i , u , n} B {R}_{n} & ( 7 - 1 )\end{matrix}$$

$${\sum }_{n = 0}^{N - 1} {α}_{i , u , n} = 1 \qquad ( 7 - 2 )$$

$${\sum }_{n = 0}^{N - 1} {α}_{i , n} \leq R \qquad ( 7 - 3 )$$

Here, α_{i, u, n} is a variable that is 1 in a case where an n-th bit rate is adopted for a video from a transmission source user i to a transmission destination user u and is 0 in a case where the n-th bit rate is not adopted for the video. Expression (7-2) represents a constraint that only one n is adopted for a certain set of i and u. Expression (7-3) represents a constraint that the number of the upload bit rates from a certain transmission source user i is equal to or smaller than R. That is, α_{i, n} is a variable that is 1 in a case where α_{i, u, n} for a certain u is 1 and is 0 in a case where α_{i, u, n} for all u is 0. The upload bit rate selection unit 13 calculates Expression (7-1) in consideration of the constraints of Expression (7-2) and Expression (7-3) in addition to the constraints of Expression (2) to Expression (6). Thereby, it is possible to determine the bit rates for each of combinations of transmission source users x transmission destination users while limiting the number of the upload bit rates from each transmission source user i to be equal to or smaller than R. Note that the upload bit rate selection unit 13 sets the n-th bit rate with d_{i, u, n}=1, as BR_{i, u}(t) for (i, u).

In each embodiment, the control server 10 is an example of a bit rate selection device. The client terminal 20 is an example of a first terminal and a second terminal. The upload bit rate selection unit 13 is an example of a selection unit. The upload bit rate instruction unit 14 is an example of an instruction unit. The distribution server 30 is an example of a distribution device.

Although the embodiments of the present invention have been described in detail above, the present invention is not limited to such a specific embodiment, and various modifications and changes can be made within the scope of the gist of the present invention described in the claims.

This application claims the priority based on International Patent Application No. PCT/JP2022/019985, filed on May 11, 2022, which is incorporated herein by reference in its entirety.

### REFERENCE SIGNS LIST

10 Control server
11 Client log collection unit
12 Target QoE input unit
13 Upload bit rate selection unit
14 Upload bit rate instruction unit
20 Client terminal
21 Client log transmission unit
22 Upload bit rate control unit
23 Transmission data encoding unit
24 Reception data decoding unit
30 Distribution server
100 Drive device
101 Recording medium
102 Auxiliary storage device
103 Memory device
104 CPU
105 Interface device
B Bus

1. A bit rate selection device comprising:
a processor, and
a memory storing program instructions that cause the processor to:
select bit rates of videos for each of combinations of a plurality of first terminals and a plurality of second terminals from a plurality of levels of values such that a sum of the bit rates of the videos for each of the combinations is minimized under a constraint that each of the plurality of second terminals receives the videos transmitted from each of the plurality of first terminals via a distribution device in online real-time communication and a quality of experience of each of the videos for a user of each of the plurality of second terminals is equal to or higher than a threshold value; and
transmit, to each of the plurality of first terminals, an instruction for instructing each of the plurality of first terminals to perform encoding at one or more bit rates selected for each of the combinations related to the first terminals.

2. The bit rate selection device according to claim 1, wherein
the program instructions cause the processor to select the bit rates of the videos for each of the combinations under a constraint that a sum of the bit rates excluding redundancy of the bit rates for each of the combinations is within an available band for upload from the plurality of first terminals to the distribution device.

3. The bit rate selection device according to claim 1, wherein
the program instructions cause the processor to select the bit rates of the videos for each of the combinations under a constraint that a sum of the bit rates for each of the combinations is within an available band for download from the distribution device to the plurality of second terminals.

4. The bit rate selection device according to claim 1, wherein
the program instructions cause the processor to select the bit rates of the videos for each of the combinations under a constraint that the number of the bit rates at which each of the plurality of first terminals transmits the video is equal to or smaller than a predetermined number.

5. A bit rate selection method executed by a computer, the bit rate selection method comprising:
selecting bit rates of videos for each of combinations of a plurality of first terminals and a plurality of second terminals from a plurality of levels of values such that a sum of the bit rates of the videos for each of the combinations is minimized under a constraint that each of the plurality of second terminals receives the videos transmitted from each of the plurality of first terminals via a distribution device in online real-time communication and a quality of experience of each of the videos for a user of each of the plurality of second terminals is equal to or higher than a threshold value; and
transmitting, to each of the plurality of first terminals, an instruction for instructing each of the plurality of first terminals to perform encoding at one or more bit rates selected for each of the combinations related to the first terminals.

6. The bit rate selection method according to claim 5, wherein
the selecting of the bit rates further includes selecting the bit rates of the videos for each of the combinations under a constraint that a sum of the bit rates excluding redundancy of the bit rates for each of the combinations is within an available band for upload from the plurality of first terminals to the distribution device.

7. The bit rate selection method according to claim 5, wherein
the selecting of the bit rates further includes selecting the bit rates of the videos for each of the combinations under a constraint that a sum of the bit rates for each of the combinations is within an available band for download from the distribution device to the plurality of second terminals.

8. A non-transitory computer-readable recording medium storing a program for causing a computer to execute a process comprising:
selecting bit rates of videos for each of combinations of a plurality of first terminals and a plurality of second terminals from a plurality of levels of values such that a sum of the bit rates of the videos for each of the combination is minimized under a constraint that each of the plurality of second terminals receives the videos transmitted from each of the plurality of first terminals via a distribution device in online real-time communication and a quality of experience of each of the videos for a user of each of the plurality of second terminals is equal to or higher than a threshold value; and
transmitting, to each of the plurality of first terminals, an instruction for instructing each of the plurality of first terminals to perform encoding at one or more bit rates selected for each of the combinations related to the first terminals.
